(19) United States
(12) Patent Application Publication
(10) Pub. No.: US 2017/0314228 A1
(43) Pub. Date: Nov. 2, 2017

(54) MULTI-PURPOSE BUCKET

(71) Applicant: X HAND INC., Calgary (CA)

(72) Inventor: Chester Lea Sirr, Kelowna (CA)

(73) Assignee: X HAND INC., Calgary (CA)

(21) Appl. No.: 15/141,688

(22) Filed: Apr. 28, 2016

(51) Int. Cl. E02F 7/06; E02F 3/40; B07B 1/00

(52) U.S. Cl. CPC E02F 7/06; B07B 1/005; E02F 3/40

(57) ABSTRACT

Disclosed is an apparatus for screening material at the end of an excavator arm comprising a blade having a bottom edge, a top edge and a connector therebetween for securing to a distal end of the arm of a earth moving equipment. The bucket has a bottom screen having front and rear edges being rotatable about the top edge of the blade section. The bottom screen is positionable so as to extend angled away from the bottom edge of the blade. The bucket further comprises a front screen rotatable relative to the bottom screen having a main portion and an angled bottom portion. The front screen is positionable to a closed position proximate the front edge of the bottom screen such that the front edge of the bottom screen extends past the angled bottom portion of the front screen.

### BACKGROUND OF THE INVENTION

### 1. Field of Invention

The present invention relates to screening material, and in particular to a particle size separating bucket for earth moving equipment.

### 2. Description of Related Art

The requirement for screening aggregate or the like on the site of a construction operation normally requires the use of a separate screen of one form or another. To achieve the required result, a front end loader, backhoe or other earth moving type equipment is used to load the screen and eventually pick-up the screened (separated) material and/or the rejects and move them to their place of utility.

At many remote locations, it is often necessary to both excavate material and to provide screened material for the same site. In such locations, it is frequently necessary to excavate the material and remove it from the site with a dump truck or the like. It is also necessary to transport screened material back to the same site for use in construction of roads and the like. Such duplication of equipment and transportation is unnecessary and cost prohibitive for many job sites. Previous attempts to provide equipment that functions, not just as an earth mover but also as a particle screening or separating device have not been suitable.

Such previous attempts to provide a screening devices have not enabled the screening apparatus to also function as an excavating bucket. Although previous screens have been utilized on loading buckets, such buckets do not enable the operator to dig substantially below grade as does an excavator bucket. Such devices also require an external power or agitating source such as a vibrator to ensure the material will be passed through the screen. Such vibrators add wear and tear to the device as well as add additional complexity.

U.S. Pat. No. 8,112,913 issued Feb. 14, 2012 to Sirr describes a multi-configurable bucket for screening material comprising a blade having a bottom edge, a top edge and a connector therebetween for securing to a distal end of the arm of a earth moving equipment. Such devices however utilize hydraulic or other linear actuators to effect rotational movement between the elements of such bucket. Consequently, it is necessary to extend at least one end of such actuators either along the face of one of the screening elements thereby reducing the effective screening area of such screen or to the outside of the screening element where it is prone to damage from the soil formation, impacts with other objects or the like.

### SUMMARY OF THE INVENTION

According to a first embodiment of the present invention there is disclosed an apparatus for screening material at the end of an excavator arm comprising a blade having a bottom edge, a top edge and a connector therebetween for securing to a distal end of an arm of an earth moving equipment and a bottom screen having front and rear edges being rotatable about the top edge of the blade section, the bottom screen being positionable so as to extend angle away from the bottom edge of the blade. The multi-configurable bucket further comprises a front screen rotatable about a pivot axis relative to the bottom screen having a main screen portion and an angled end screen portion, the front screen being positionable to a closed position proximate the front edge of the bottom screen such that the front edge of the bottom screen extends past the end portion of the front screen and a rotary actuator having an axis along the pivot axis adapted to rotate the front screen relative to the bottom screen.

The front screen may extend between side plates oriented perpendicular to a screening surface of the front screen. The bottom screen may extend from side plates extending perpendicularly therefrom. The side plates of the front screen and the bottom screen may overlap through the pivot axis.

The rotary actuator may include a housing secured to the side plate of the front screen. The rotary actuator may include a drive shaft operable coupled to the side plate of the bottom screen. The screening surface may be unobstructed between the side plate of the front screen.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side view of an excavator having a bucket according to a first embodiment of the present invention on the end of it's arm.

FIG. 2 is a cross-sectional view of the bucket of FIG. 1 taken along the line 2-2 in a closed position.

FIG. 3 is a cross-sectional view of the bucket of FIG. 1 taken along the line 2-2 in an open excavating position.

FIG. 4 is a cross-sectional view of the bucket of FIG. 1 taken along the line 2-2 in an open loading position.

FIG. 5 is a perspective view of the screen and supporting tines of the bucket of FIG. 1.

FIG. 6 is a front view of the bucket of FIG. 1.

FIG. 7 is a cross-sectional view of the pivot of the bucket of FIG. 1 as taken along the line 7-7 in FIG. 6.

### DETAILED DESCRIPTION

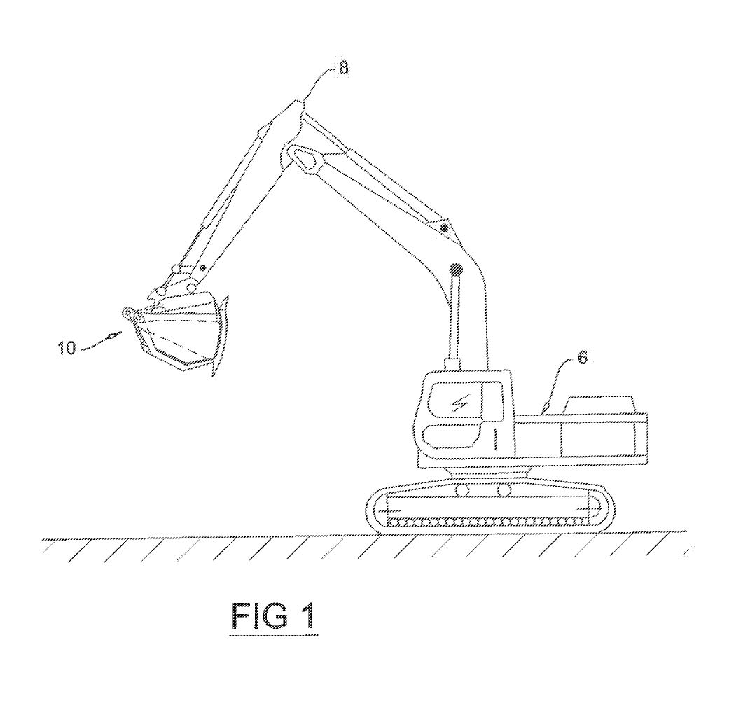

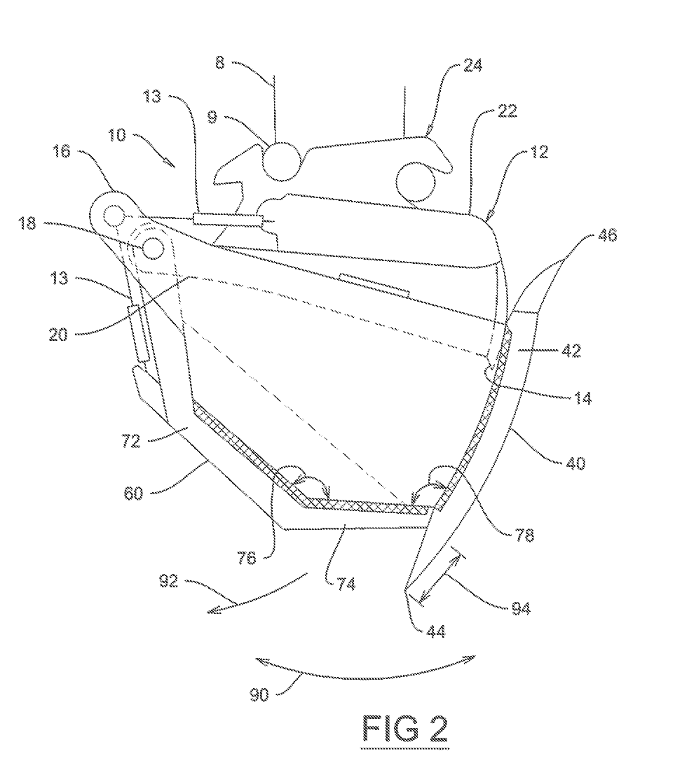

Referring to FIGS. 1 through 5, an apparatus or bucket for screening material according to a first embodiment of the invention is shown generally at 10 supported on the end of the articulated arm or boom 8 of an earth moving vehicle 6 or the like. Although the bucket 10 is shown on the end of an excavator arm, it will be appreciated that the bucket may be utilized with other types of earth moving vehicles as well, such as by way of non-limiting example, a loader or a front end loader. The present bucket 10 will enable the operator of the earth moving vehicle 6 to excavate, load, or screen soil material. With reference to FIGS. 2 through 4, the bucket 10 comprises a blade 12, a bottom screen 40 and a front screen 60 pivotally secured to each other to as to be arrangable in a plurality of orientations to suite differing functions. The front screen 60 and bottom screen 40 may be rotated relative to the blade by any conventional arrangement of hydraulic cylinders 13 as are commonly known.

The bucket 10 may be mounted on any suitable moving device, such as the arm 8 and in any conventional manner and movable relative to the earth moving vehicle 6 via a hydraulic cylinder(s) or the like. Generally, blade 12 of the bucket 10 is pivotably mounted at the free end of the arm 8 via a pivot connection 9 as are conventionally known. The orientation of the bucket 10 relative to the arm 8 or earth moving vehicle 6 is regulated by a suitable hydraulic cylinder or the like.

The blade 12 comprises an elongate body having bottom and top edges, 14 and 16, respectively and front and rear surfaces, 20 and 22, respectively. The rear surface 22 includes a connector 24 of a known type for connecting the bucket 10 to the distal end of the arm 8 of a piece of earth moving vehicle 6. Although a quick coupler type connection is illustrated in the accompanying figures, it will be appreciated that other types of connectors may be utilized as well. The top edge 16 of the blade 12 includes a pivot 18 for pivotally mounting the bottom and front screens 40 and 60. As illustrated the bottom and front screens 40 and 60 may be pivotally secured to the blade 12 at a common pivot 18. Alternatively, the bottom and front screens 40 and 60 may be pivotally mounted to the blade about separate pivot mounts. In still further embodiments, the front screen 60 may be pivotally mounted to the bottom screen 40 while the bottom screen is pivotally mounted to the blade 12. The pivot 18 may comprise a pivot pin or any other known rotatable connector.

The bottom screen 40 comprises a substantially planar or segmented screening section 42 having front and rear edges 44 and 46, respectively. The front and rear edges 44 and 46 may include smooth or toothed digging edges as are commonly known in the art. The bottom screen 40 includes a pair of axial side walls 48, only one of which is shown in the accompanying figures, one at each side of the bottom screening section 42. Each side wall 48 includes a top distal end 50 which is pivotally connected to the pivot 18 as described above. The side walls 48 are positioned outside of the blade 12.

The front screen 60 comprises an arcuate member having a proximate end 62 pivotally connected to the blade 12 and a free distal edge 64. The front screen comprises a plurality of tines as are commonly known supporting a screening panel. The front screen 60 includes a pair of axial side walls 70, only one of which is shown in the accompanying figures which may be received between the side walls 48 of the bottom screen. As illustrated, the front screen 60 comprises a plurality of segments angularly connected to each other to form the arcuate shape illustrated. The front screen 60 includes a main portion 72 and an end portion 74, the purpose of which will be more fully described below. The main portion 72 and end portion are angularly connected to each other so as to form a first angle generally indicated at 76 therebetween

As illustrated in FIG. 2, the bucket 10 may be configured such that the blade 12, bottom screen 40 and front screen 60 are continuous with each other in a closed or screening configuration. In such a configuration, the bucket 10 may be utilized to screen or sift soil or other material therein. As illustrated, in the screening configuration, the end portion 74 of the front screen 60 and the bottom screen 40 form a second angle generally indicated at 78 therebetween. In the screening configuration, the bucket 10 may be rocked or otherwise cyclically moved back and forth in a rotational motion as indicated generally at 90. In such a motion, the soil contained within the bucket 10 will be moved back and forth across the bottom and front screen 40 and 60 so as to assist in the bucket in screening the material. The first and second angles should be chose so as to not unduly impede movement of the soil over the screens. In particular, the applicant has found that angles of greater than 100 degrees has been useful for the first and second angles 76 and 78 although it will be appreciated that wider angles will be more useful for allowing movement of material within the bucket.

Additionally, in the configuration shown in FIG. 2, the bucket 10 may also be utilized for moving soil or forwarding. The exterior of the front screen 60 and the front edge 44 of the bottom screen 40 of the bucket 10 may be engaged against a soil formation and thereafter utilized to push the soil forward in a motion generally indicated at 92. As illustrated, the bottom portion 74 of the front screen 60 is set back from the front edge 44 of the bottom screen by a setback distance generally indicated at 94. It will be appreciated that locating the end portion 74 back of the front edge 44 will prevent the tines and screen material of the front screen 60 from being damaged by such a motion as the front edge 44 which is better suited to digging will primarily engage the soil. This will also prevent the tines from becoming jammed and clogged by soil and rock from such a motion. In practice, it has been found that a set back distance of 6 inches has been suitable, although it will be appreciated that other distances may be useful as well.

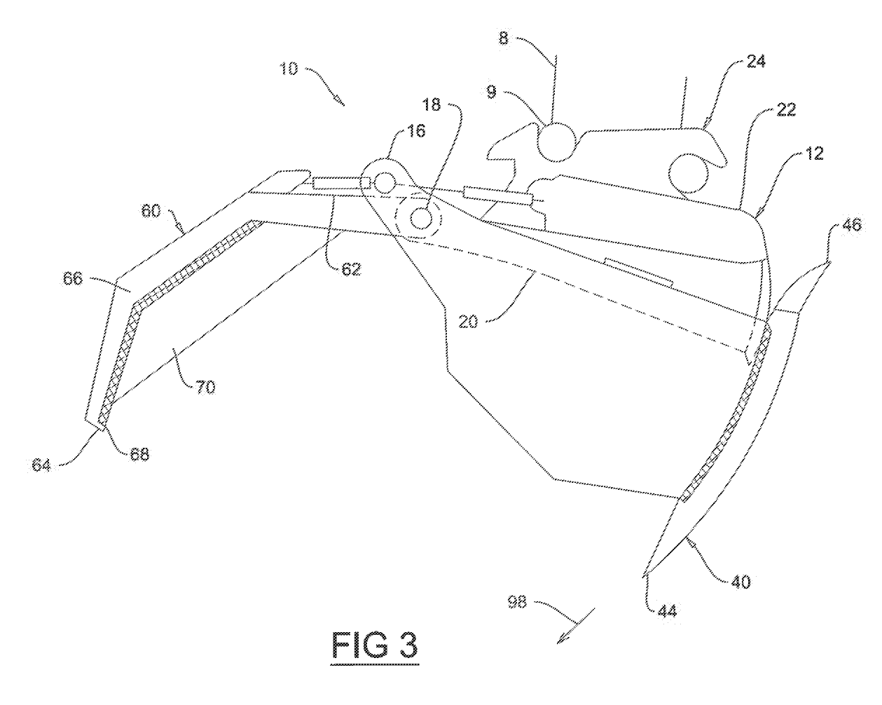

Turning now to FIG. 3, the bucket 10 may be utilized for loading by opening the front screen 60 away from the bottom screen 40 and may thereafter be used to scoop material at or above grade as is typically performed by a loader with a loading motion generally indicated at 98. It will be appreciated, that such a movement may be utilized for conventional loading as well as to fill the bucket 10 with material that is to be screened as illustrated in FIG. 2. In such a sequence, after the bucket 10 has been filled, the front screen 60 may be moved to the position showing in FIG. 2 and thereafter utilized to screen the material as described above.

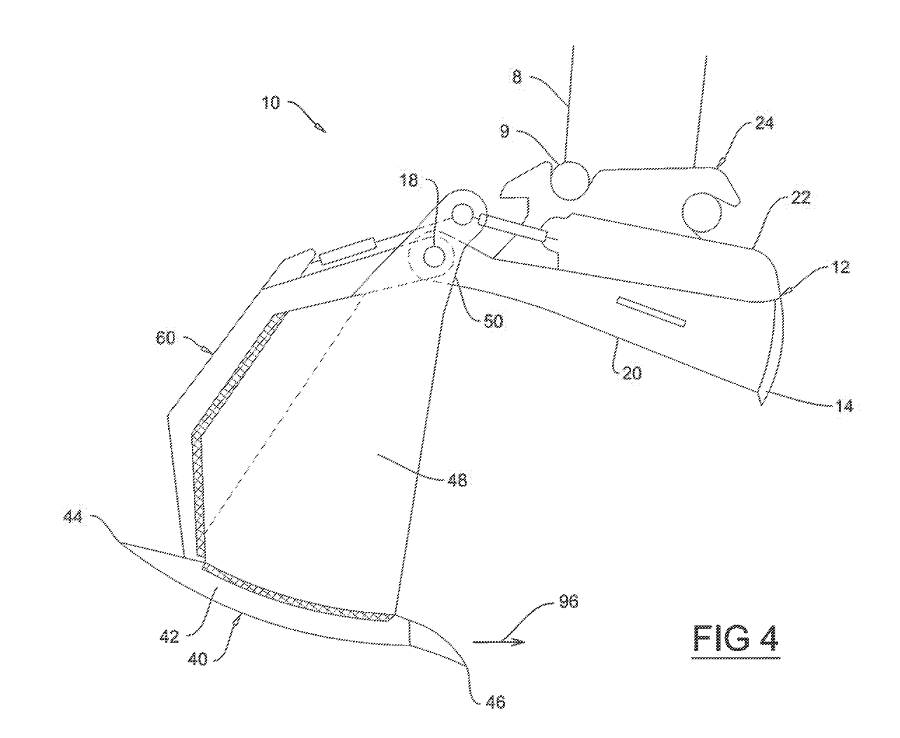

With reference to FIG. 4, the bucket 10 may also be utilized in an excavating configuration as shown. In the excavating configuration, the front and bottom screen 60 and 40 are rotated away from the blade 12 and moving the bucket in a downward motion towards the earth moving vehicle 6 as generally indicated at 96. It will be appreciated, that such a movement may be utilized for conventional loading as well as to fill the bucket 10 with material that is to be screened as illustrated in FIG. 2. In such a sequence, after the bucket 10 has been filled, the front screen 60 may be moved to the position showing in FIG. 2 and thereafter utilized to screen the material as described above.

It will be seen that through the use of the bucket 10 of the present description, work can be generated (i.e. the bucket filled) in the normal excavating direction as well as in the opposite direction, creating a significant improvement in productivity for an excavator. Conventional excavators only generate work in one direction, by digging toward the excavator. In such an operation, the reaching out movement is only a set up to being able to dig. With the present bucket 10, material can also be forwarded with closed bucket as described above or loaded by pushing away with the cutting edge of the bottom screen. Utilizing a conventional bucket, the digging or working area is typically at grade (track level) or below. To work a pile above grade the excavator climbs the pile so it can dig below track level. With the use of the above bucket, the excavator may work above grade by front loading or below grade by digging.

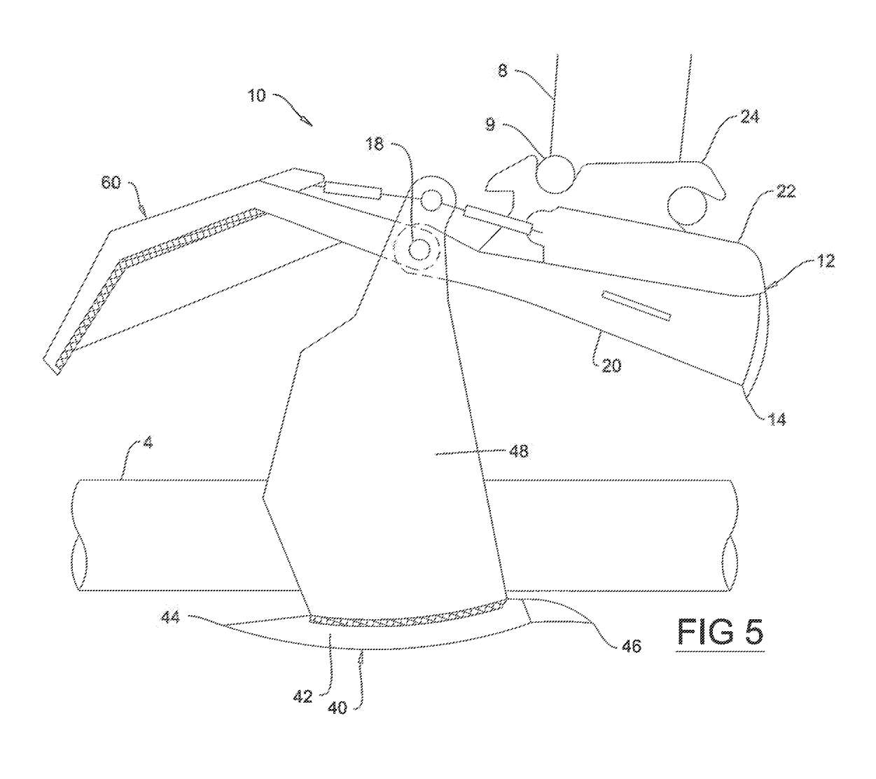

As illustrated in FIG. 5, the bucket 10 may also have the bottom screen 40 rotated away from the blade 12 and the front screen 60 rotated away from the bottom screen 40. In such a configuration, the bottom screen 40 of the bucket 10 is able to support an elongate object, such as a log 4 or the like longitudinally along the bottom screen such that the blade 12 and the front screen 60 may be engaged upon the top of the log to retain it within the bucket. The front screen 60 may be similarly formed as described above for the bottom screen. Alternatively, the front screen may be formed of a thicker material of up to 2 inches or more and retained in place with fasteners which extend through the screening member and the tines, such as by way of non-limiting example, clavicles, clamps or the like.

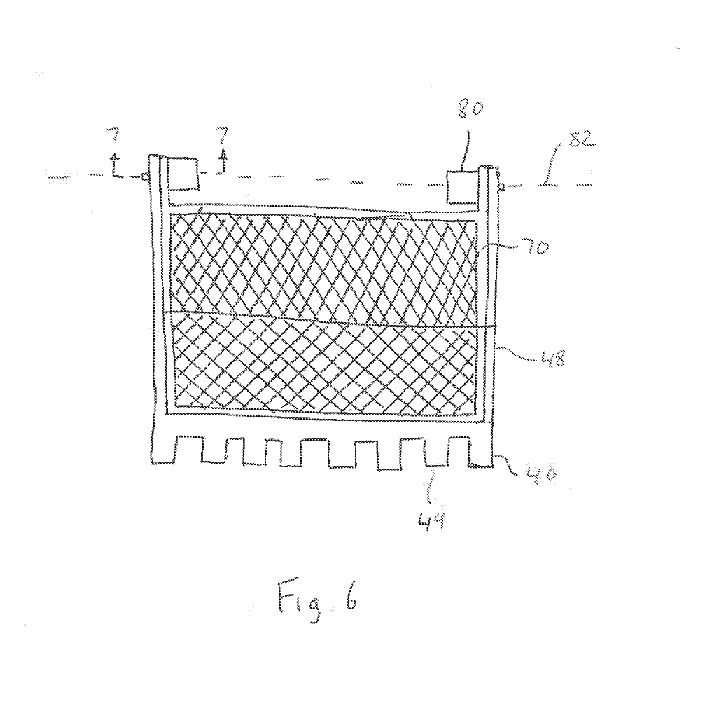

With reference to FIG. 6, the side plate 70 of front screen and the side plate 48 of the bottom screen 40 may overlap each other at a top end thereof. The side plates 70 and 48 may further be pivotable relative to each other about a pivot axis 82 extending therethrough. As illustrated the bucket may include a rotary actuator 80 located along the pivot axis for rotating the front screen 40 relative to the bottom screen 60 as described above. It will be appreciated that locating the actuator entirely above the front and bottom screens removes any requirement to provide additional structure to either side of the dise plates 70 and therefore permits both the side plates 70 and 48 to be narrower as well as prevents any external objects from impacting the actuator and its components.

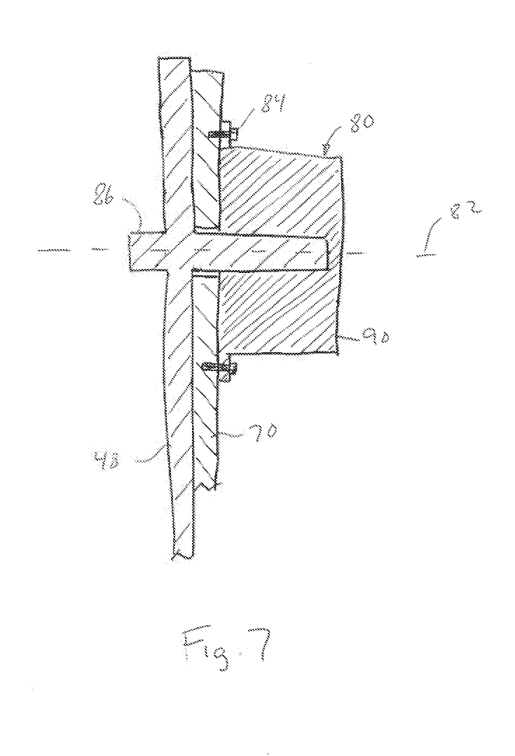

Turning to FIG. 7, the actuator 80 comprises a housing 90 secured to the side plates 7 of the front screen such as through the use of fasteners 84 or the like. The actuator 80 further includes drive shaft 86 extending therefrom. The drive shaft 86 extends through and in unconnected to a bore 88 in the side plates 70 of the front screen and is securely connected to the side plate 48 of the bottom screen. In such a manner it will be appreciated that rotation of the rotary actuator, the front and bottom screens will be rotated relative to each other along the pivot axis 82. It will be appreciated that although the housing is shown connected to the front screen and the shaft connected to the bottom screen that the reverse connection may also be provided in which the bottom screen is connected to the housing and the front screen connected to the drive shaft. The rotary actuator may of any known type, such as by way of non-limiting example, electric, hydraulic or pneumatic. Although the rotary actuator 80 is illustrated operating the front screen 70 of the apparatus 10, it will be appreciated that a similar rotary actuator may be applied to operate the bottom screen 40 and thereby to achieve a similar increase in screening surface area.

While specific embodiments of the invention have been described and illustrated, such embodiments should be considered illustrative of the invention only and not as limiting the invention as construed in accordance with the accompanying claims.

What is claimed is:

1. An apparatus for screening material at the end of an excavator arm comprising:
a blade having a bottom edge, a top edge and a connector therebetween for securing to a distal end of an arm of an earth moving equipment;
a bottom screen having front and rear edges being rotatable about top edge of said blade section, said bottom screen being positionable so as to extend angle away from said bottom edge of said blade;
a front screen rotatable about a pivot axis relative to said bottom screen having a main screen portion and an angled end screen portion, said front screen being positionable to a closed position proximate said front edge of said bottom screen such that said front edge of said bottom screen extends past said end portion of said front screen; and
a rotary actuator having an axis along said pivot axis adapted to rotate said front screen relative to said bottom screen.

2. The apparatus of claim 1 wherein said front screen extends between side plates oriented perpendicular to a screening surface of said front screen.

3. The apparatus of claim 2 wherein said bottom screen extends from side plates extending perpendicularly therefrom.

4. The apparatus of claim 3 wherein said side plates of said front screen and said bottom screen overlap through said pivot axis.

5. The apparatus of claim 4 wherein said rotary actuator includes a housing secured to said side plate of said front screen.

6. The apparatus of claim 5 wherein said rotary actuator includes a drive shaft operable coupled to said side plate of said bottom screen.

7. The apparatus of claim 2 wherein said screening surface is unobstructed between said side plate of said front screen.
